(19) United States
(12) Patent Application Publication
(10) Pub. No.: US 2025/0089078 A1
(43) Pub. Date: Mar. 13, 2025

(54) SOUNDING REFERENCE SIGNAL (SRS) PORT NUMBER ADAPTION FOR UPLINK SWITCH ENHANCEMENT

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/632,161

(22) Filed: Apr. 10, 2024

Related U.S. Application Data
(60) Provisional application No. 63/581,031, filed on Sep. 7, 2023.

(51) Int. Cl. H04W 72/51; H04L 5/00; H04W 28/02; H04W 88/04; H04W 92/18

(52) U.S. Cl. CPC H04W 72/51; H04L 5/0051; H04L 5/0053; H04W 28/0263; H04W 88/04; H04W 92/18

(57) ABSTRACT

Certain aspects of the present disclosure provide a method for wireless communications at a user equipment (UE). The UE may transmit UE capability information indicating support for multiple sounding reference signal (SRS) port adaptation patterns to a network entity. Each SRS port adaptation pattern defines a series of SRS transmissions and indicates whether each SRS transmission is a single-port SRS transmission or a multi-port SRS transmission. The UE may receive, from the network entity, a configuration of the multiple SRS port adaptation patterns based on the UE capability information, UE traffic, etc. The UE may dynamically select and/or switch an SRS port adaptation pattern per time slot for sending SRS transmissions.

### CROSS-REFERENCE TO RELATED APPLICATION

This application claims benefit of and priority to U.S. Provisional Patent Application No. 63/581,031, filed Sep. 7, 2023, which is hereby incorporated by reference in its entirety.

### BACKGROUND

### Field of the Disclosure

Aspects of the present disclosure relate to wireless communications, and more particularly, to techniques for managing sounding reference signal (SRS) port patterns for single-port and multi-port SRS transmissions.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes transmitting UE capability information indicating support for multiple sounding reference signal (SRS) port patterns, wherein each SRS port pattern defines a series of SRS transmissions and indicates whether each SRS transmission is a single-port SRS transmission or a multi-port SRS transmission; and receiving a configuration of the multiple SRS port patterns, in accordance with the UE capability information.

Another aspect provides a method for wireless communications at a network entity. The method includes receiving UE capability information indicating support for multiple SRS port patterns, wherein each SRS port pattern defines a series of SRS transmissions and indicates whether each SRS transmission is a single-port SRS transmission or a multi-port SRS transmission; and transmitting a configuration of the multiple SRS port patterns, in accordance with the UE capability information.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIG. 4A, FIG. 4B, FIG. 4C, and FIG. 4D depict various example aspects of data structures for a wireless communications network.

FIG. 5, FIG. 6, and FIG. 7 depicts example uplink transmit (Tx) switching options and cases.

FIG. 8 depicts example comparison between uplink Tx switching option 1 versus uplink Tx switching option 2 and time division duplexing (TDD) versus frequency division duplexing (FDD).

FIG. 9 depicts a call flow diagram illustrating example communication among wireless nodes such as a UE and a network entity.

FIG. 10 depicts a method for wireless communications at a wireless node such as a UE.

FIG. 11 depicts a method for wireless communications at a wireless node such as a network entity.

FIG. 12 and FIG. 13 depict example communications devices.

### DETAILED DESCRIPTION

Aspects of the present disclosure provide apparatuses, methods, processing systems, and computer-readable mediums for managing sounding reference signal (SRS) port patterns for single-port and multi-port SRS transmissions.

An SRS is a reference signal used to measure an uplink channel. A gNodeB (gNB) may measure the uplink channel based on the SRS sent by a user equipment (UE) to determine channel conditions (or a quality of the uplink channel) and schedule uplink resources. An SRS resource set may be used to transmit (e.g., broadcast) the SRS using a plurality of antenna ports (such as port 0, port 1, etc.). The SRS resource set may be configured for different types of usages including a codebook based transmission and a non-codebook based transmission. One SRS resource set may include one or more SRS resources for one or more antenna ports. In some cases, the UE may be configured to send the SRS on one or two antenna ports, which may be arranged in a fixed pattern (i.e., a single-port SRS transmission via one antenna port, a multi-port SRS transmission via two or more antenna ports).

Due to thermal and power consumption limitations of the UE, the UE may have a limited number of radio frequency (RF) chains for processing and receiving/transmitting signals. For example, the UE may have two RF chains (e.g., two transmit (Tx) chains, two Tx/receive (Rx) chains, and/or two Rx chains). The UE may be configured to communicate on multiple carriers or frequency bands (e.g., using a carrier aggregation (CA)), such as on an uplink. For example, if the UE has two Tx chains and is configured to communicate on two carriers on the uplink, in certain cases, the UE may be configured to use one Tx chain per carrier.

However, in certain cases, the UE may be configured to use uplink multiple inpute multiple output (MIMO) for communicating on the uplink, such as on a primary cell (Pcell) (e.g., on a time division duplex (TDD) band with 100 MHz bandwidth). In particular, in some cases, the UE may use multiple Tx chains for communication using the MIMO on a single carrier on the uplink. Accordingly, in a two Tx chains example, the UE may need to perform an uplink Tx switching, where one or more Tx chains are switched between communicating on multiple different carriers. For example, a Tx chain may be switched from communicating on a first carrier on the uplink at a first time, to communicating on a second carrier on the uplink at a second time. In another example, the UE may support the uplink Tx switching to accommodate communication on a greater number of carriers (e.g., three carriers) than the UE has Tx chains (e.g., two Tx chains). It should be noted there may be other reasons the UE needs to support the uplink Tx switching.

For typical uplink multi-carrier operations, the UE is configured to use one Tx chain for a first carrier and another Tx chain for a second carrier. However, in some cases, the UE may perform the uplink Tx switching to use both its Tx chains to send data on one carrier (i.e., for a two-layer transmission by the UE). To notify the gNB that the UE may send the two-layer transmission on a given carrier, the UE may primarily use SRSs (e.g., a two-port SRS transmission by the UE to the gNB). To send an SRS via the two antenna ports, the UE may have to implement the uplink Tx switching to switch from one Tx chain per carrier configuration (e.g., which may be applicable for most transmission cases) to two Tx chains-one carrier configuration. This is because the two Tx chains may be needed to send the two-port SRS transmission to the gNB.

Certain issues may arise when the UE frequently implements the uplink Tx switching (e.g., each time the two-port SRS transmission is initiated by the UE). For example, the time it takes for the UE to perform the uplink Tx switching from one carrier to another carrier (e.g., referred to herein as an uplink Tx switching time) may impact when the UE can communicate on the uplink, such as a physical uplink shared channel (PUSCH). In particular, the UE may not be able to communicate on the uplink while performing the uplink Tx switching for the uplink Tx switching time, and in some cases may not be able to even prepare data for transmission on the uplink while performing the uplink Tx switching for the uplink Tx switching time. Hence, the uplink Tx switching time may affect uplink data preparation time of the UE as well as cause a total uplink throughput loss (e.g., as the UE is not able to communicate on the uplink while performing the uplink Tx switching).

To reduce the total uplink throughput loss, techniques proposed herein may reduce unnecessary uplink Tx switching, which may be triggered by initiation of the two-port SRS transmission. For example, the techniques proposed herein may support SRS port configuration adaptation instead of a fixed SRS port configuration (e.g., which may facilitate a two-port SRS transmission even when it's not needed). For example, a gNB may define and configure multiple SRS port patterns (e.g., also called as SRS port adaptation patterns) for a UE, where each SRS port pattern is unique and defines an arrangement of SRS ports for single-port SRS transmissions as well as multi-port SRS transmissions. The use of one of the SRS port patterns prevents the UE from unnecessarily transmitting the two-port SRS transmission (e.g., where the UE can simply use a one-port SRS transmission) and thereby prevents the triggering of the uplink Tx switching.

Particular aspects of the subject matter described in this disclosure can be implemented to realize one or more of the following potential advantages. In some examples, the described techniques can lead to a higher uplink throughput due to reduced unnecessary uplink Tx switching.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

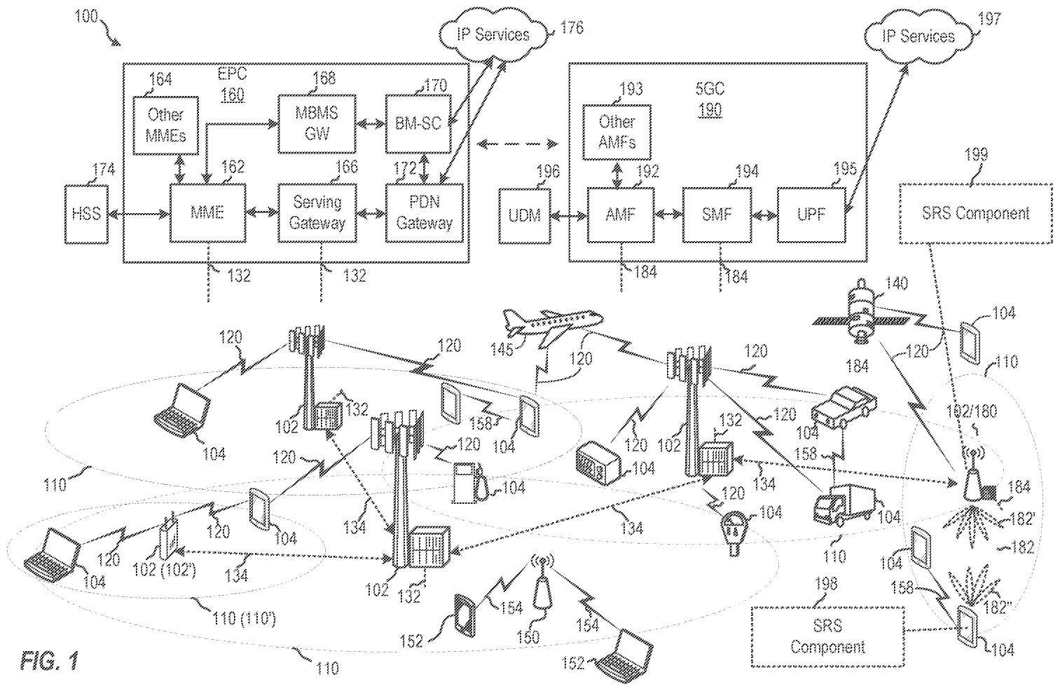

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

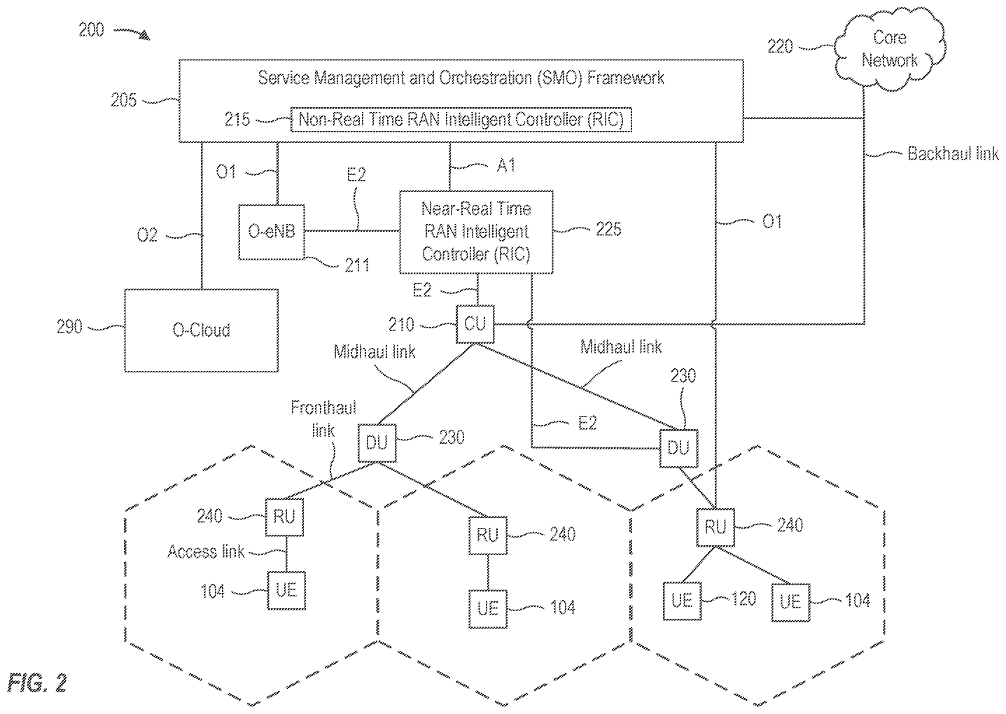

While BSs 102 are depicted in various aspects as unitary communications devices, BSs 102 may be implemented in various configurations. For example, one or more components of a BS 102 may be disaggregated, including a central unit (CU), one or more distributed units (Dus), one or more radio units (Rus), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mm Wave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

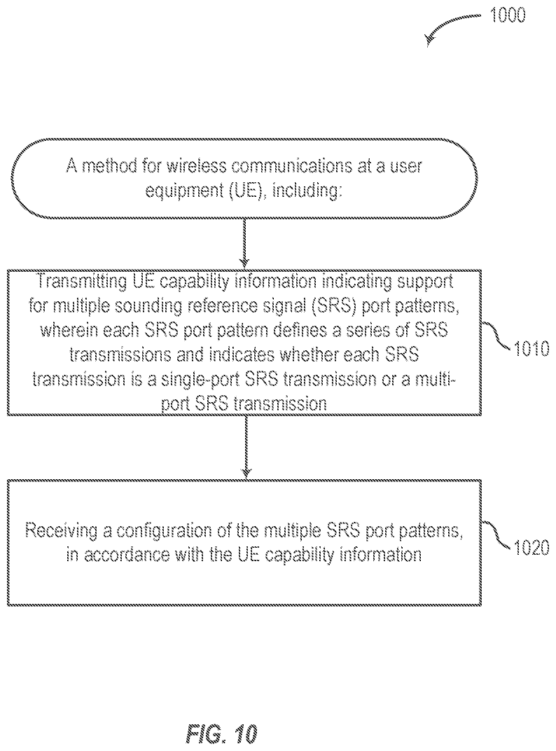

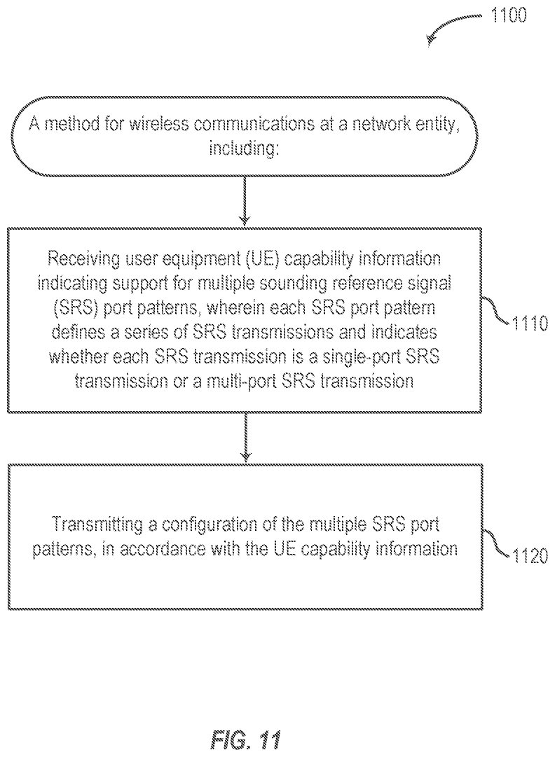

Wireless communication network 100 further includes sounding reference signal (SRS) component 198, which may be configured to perform method 1000 of FIG. 10. Wireless communication network 100 further includes SRS component 199, which may be configured to perform method 1100 of FIG. 11.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (Cus) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (Dus) 230 via respective midhaul links, such as an F1 interface. The Dus 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as Al policies).

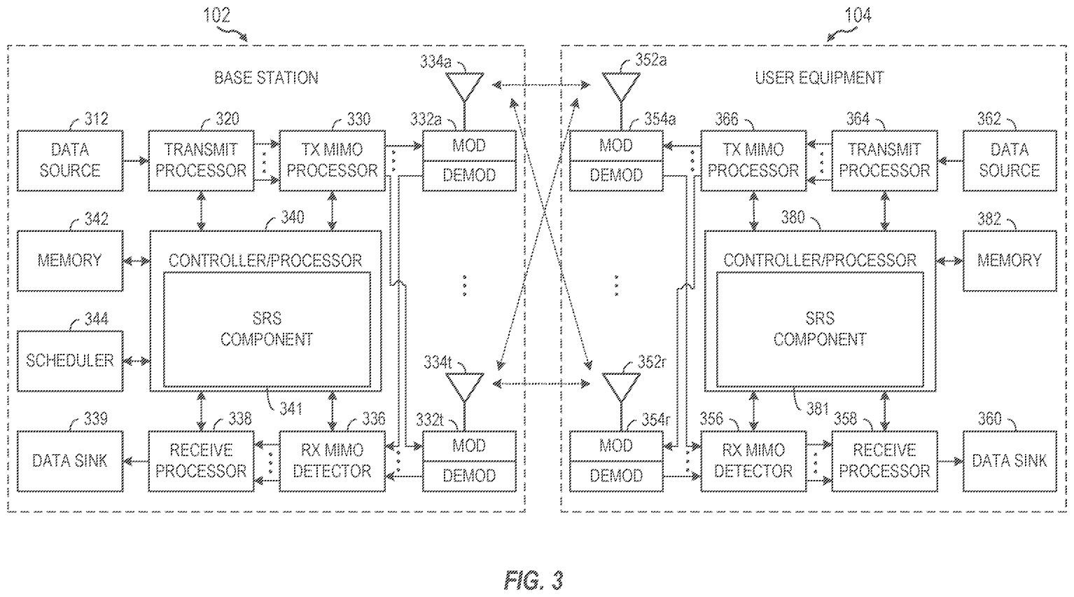

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes SRS component 341, which may be representative of SRS component 199 of FIG. 1. Notably, while depicted as an aspect of controller/processor 340, SRS component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes SRS component 381, which may be representative of SRS component 198 of FIG. 1. Notably, while depicted as an aspect of controller/processor 380, SRS component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

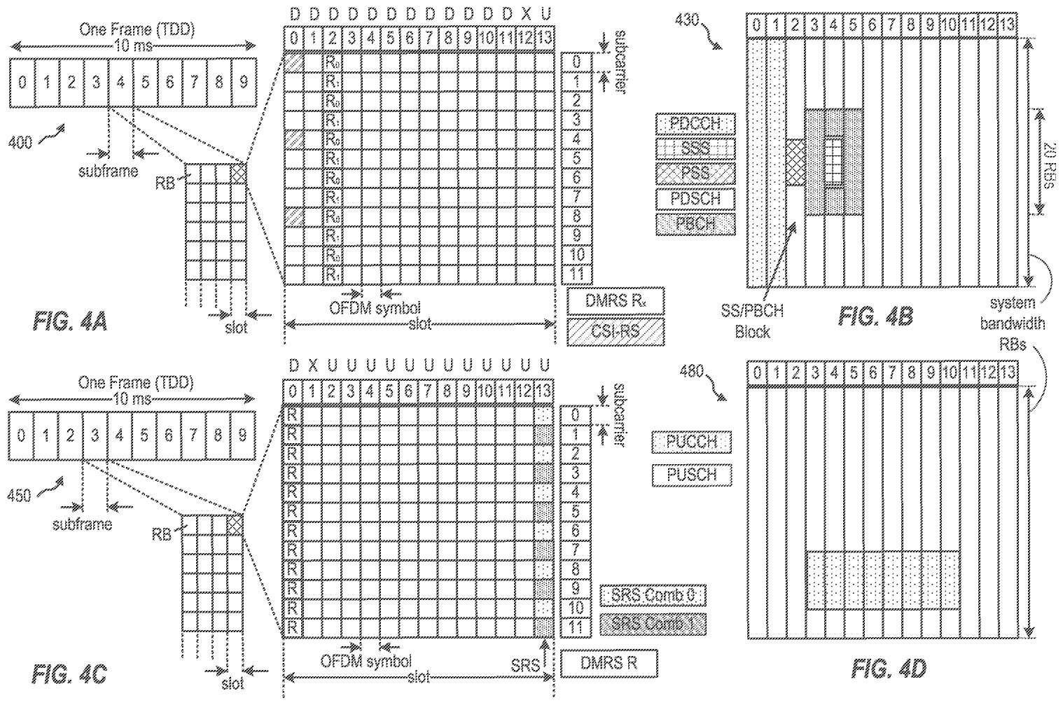

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3^{rd} generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mm Wave/near mm Wave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Sounding Reference Signal (SRS)

A sounding reference signal (SRS) is a reference signal used to measure an uplink channel. A gNodeB (gNB) may measure the uplink channel based on the SRS sent by a user equipment (UE) to determine channel conditions or a quality of the uplink channel and schedule uplink resources. An SRS resource set may be used to transmit (e.g., broadcast) the SRS using a plurality of antenna ports (such as, port 0, port 1, etc.). The SRS resource set may be configured for different types of usages including a codebook based transmission and a non-codebook based transmission. One SRS resource set may include one or more SRS resources for one or more antenna ports.

In communications systems, the UE can be configured for sending the SRS on 1, 2 or 4 antenna ports for uplink link adaptation. The SRS can be configured to use 1, 2 or 4 symbols in a time domain. The UE may also transmit the SRS using multiple antenna ports for downlink link adaptation when channel reciprocity is available, e.g., for determining a downlink precoding matrix.

A multi-port SRS transmission may be the SRS transmitted by the UE using 2 or 4 antenna ports. In some cases, all ports (e.g., ports 0, 1, 2, and 3) are used within one single carrier (SC) frequency division multiple access (FDMA) symbol of one subframe on a same comb of subcarriers in a bandwidth using orthogonal sequences (e.g., up to 4 cyclically shifted versions of a common root sequence) for the multi-port SRS transmission.

A single-port SRS transmission can be transmitted from one of the antenna ports. There may be two modes for selecting an antenna port for the single-port SRS transmission, such as, closed loop antenna selection and open loop antenna selection. With closed loop antenna selection, the UE may select one of the antenna ports based on a gNodeB (gNB) indication. With open loop, it is up to the UE to select the antenna port.

In some cases, the SRS is transmitted using an interleaved frequency division multiple access (IFDMA) waveform, which is a special discrete Fourier transform (DFT) spread orthogonal frequency division multiplexing (DFT-S-OFDM) waveform. New radio (NR) supports use of the DFT-S-OFDM based waveform and use of a cyclic prefix (CP) orthogonal frequency division multiplexing (CP-OFDM) waveform for uplink transmissions, at least for uplink transmissions on bandwidths of up to 40 GHz.

### Overview of Transmit (Tx) Chain

A user equipment (UE) includes a radio frequency (RF) transceiver. The RF transceiver may be operated independently, and used for establishing and maintaining an active connection with a gNodeB (gNB). The RF transceiver may be embodied in an RF modem, and includes at least one transmit (Tx) chain and at least one receive (Rx) chain to support bi-directional communication. The RF modem may assign RX chains and Tx chains for each RF transceiver. A Tx chain may include modulators, encoders, amplifiers and other devices and circuits. An Rx chain may include amplifiers, demodulators, decoders and other devices and circuits.

The Tx chains may also be called as baseband chains or RF Tx chains. The Tx chains enable active and multiple transmissions. For example, when the UE has two Tx chains, the UE is enabled to have two transmissions at a same time.

In current systems, the UE is normally configured with two Tx chains associated with two frequency bands (or carriers). For example, a first Tx chain of the UE is associated with a first frequency band and a second Tx chain of the UE is associated with a second frequency band. The UE may implement a Tx chain switching scheme (e.g., uplink Tx switching) to switch the two TX chains between the two frequency bands (e.g., may be based on supplementary uplink (SUL) and/or new radio (NR) inter-band uplink carrier aggregation (CA) band combination). In some cases, the TX chain switching scheme may enable the switching between different transmissions such as two-layer transmissions and single-layer transmissions.

A switching time duration corresponds to an interval or period of time the UE takes to switch the Tx chains. The switching time duration may be defined per frequency band pair. In one example, the switching time duration for the Tx chains per frequency band pair is 35 microseconds (usec). In another example, the switching time duration for the Tx chains per frequency band pair is 140 usec. In yet another example, the switching time duration for the Tx chains per frequency band pair is 210 usec.

### Overview of Carrier Aggregation (CA)

A carrier refers to a set of radio frequency spectrum resources having a defined physical layer structure for supporting communications over a communication link. For example, a carrier of a communication link may include a portion of a radio frequency spectrum band that is operated according to physical layer channels for a given radio access technology. Each physical layer channel may carry user data, control information, or other signaling. A carrier may be associated with a pre-defined frequency channel. Carriers may be downlink or uplink (e.g., in a frequency division duplexing (FDD) mode), or be configured to carry downlink and uplink communications (e.g., in a time division duplexing (TDD) mode). In some examples, signal waveforms transmitted over a carrier may be made up of multiple sub-carriers (e.g., using multi-carrier modulation (MCM) techniques).

The organizational structure of the carriers may be different for different radio access technologies (e.g., new radio (NR), long term evolution (LTE), etc.). For example, communications over the carrier may be organized according to transmission time intervals (TTIs) or slots, each of which may include user data as well as control information or signaling to support decoding the user data. The carrier may also include dedicated acquisition signaling (e.g., synchronization signals or system information, etc.) and control signaling that coordinates operation for the carrier. In some examples (e.g., in a carrier aggregation (CA) configuration), the carrier may also have acquisition signaling or control signaling that coordinates operations for other carriers.

Physical channels may be multiplexed on the carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in the physical control channel may be distributed between different control regions in a cascaded manner (e.g., between a common control region or common search space and one or more user equipment (UE)-specific control regions or UE-specific search spaces).

The carrier may be associated with a particular bandwidth of the radio frequency spectrum, and in some examples the carrier bandwidth may be referred to as a “system bandwidth” of the carrier or a wireless communications system. For example, the carrier bandwidth may be one of a number of predetermined bandwidths for carriers of a particular radio access technology (e.g., 1.4, 3, 5, 10, 15, 20, 40, or 80 MHz). In some examples, each served UE may be configured for operating over portions or all of the carrier bandwidth. In other examples, some UEs may be configured for operation using a narrowband protocol type that is associated with a predefined portion or range (e.g., set of subcarriers or resource blocks (RBs)) within the carrier (e.g., “in-band” deployment of a narrowband protocol type).

Devices of the wireless communications system (e.g., gNodeB (gNB) or UEs) may have a hardware configuration that supports communications over a particular carrier bandwidth, or may be configurable to support communications over one of a set of carrier bandwidths. In some examples, the wireless communications system may include the gNBs and/or the UEs that can support simultaneous communications via carriers associated with more than one different carrier bandwidth.

The wireless communications system may support communication with a UE on multiple cells or carriers, a feature which may be referred to as CA or multi-carrier operation. That is, the CA is the feature that allows mobile operators to combine two or more carriers into single data channel to increase the capacity of a network and data rates by exploiting fragmented spectrum allocations. Each aggregated carrier may be referred to as a component carrier (CC). The UE may be configured with multiple downlink CCs and one or more uplink CCs according to a CA configuration. The CA may be used with both FDD and TDD CCs.

In some aspects, the CC may have a bandwidth of 1.4, 3, 5, 10, 15 or 20 MHz and a maximum of five CCs can be aggregated, hence the maximum aggregated bandwidth is 100 MHz. In FDD, the number of aggregated carriers can be different in downlink and uplink. However, the number of uplink CCs is always equal to or lower than the number of downlink CCs. The individual CCs can also be of different bandwidths. For TDD, the number of CCs as well as the bandwidths of each CC will normally be the same for downlink and uplink.

One way to arrange aggregation would be to use contiguous CCs within a same operating frequency band, so called intra-band contiguous. In this, the carriers are adjacent to each other and there is a need of a single transceiver as a signal is considered to be a single enlarged signal. However, this might not always be possible, due to operator frequency allocation scenarios. For non-contiguous allocation, it could either be intra-band where the CCs belong to the same operating frequency band but have a gap or gaps in between, (i.e., the carriers use the same operating band but are not adjacent to each other. In this case, there are two transceivers needed because the signal can't be treated as a single signal, adding to complexity and cost) or it could be inter-band in which case the CCs belong to different operating frequency bands. In the inter-band non-contiguous CA, since the carriers are from different operating frequency bands, multiple transceivers are needed to transmit/receive signals.

In new radio (NR) Release 15-17, some enhanced CA operations have been specified, such as cross cell scheduling, uplink transmit (Tx) switching, fast secondary cell (Scell) activation etc.

The uplink Tx switching is a technique introduced for a multi-carrier operation. This technique is used to select a better uplink carrier and a better transmission mode in a given slot for uplink transmission via up to two concurrent Tx. In Release 16, it is assumed that only one Tx can be supported on a first frequency band (or a first carrier) and two Tx can be supported on a second frequency band (or a second carrier) by Tx switching from the first frequency band. With more frequency bands supporting two Tx, two Tx transmission on each of the two frequency bands is specified in Release 17 by switching of both Tx between two frequency bands. However, there are some limitations of current mechanism, e.g., a UE can only be configured with at most two uplink frequency bands, which can only be changed by radio resource control (RRC) (re) configuration, and uplink Tx switching can be only performed between two uplink frequency bands for two Tx capable UE. The uplink Tx switching across up to three or four frequency bands with up to two Tx simultaneous transmission is under consideration. This technique is also helpful for support of the enhanced CA framework as more uplink carriers from more than two uplink frequency bands could be the typical scenarios for uplink use cases via flexible carrier association.

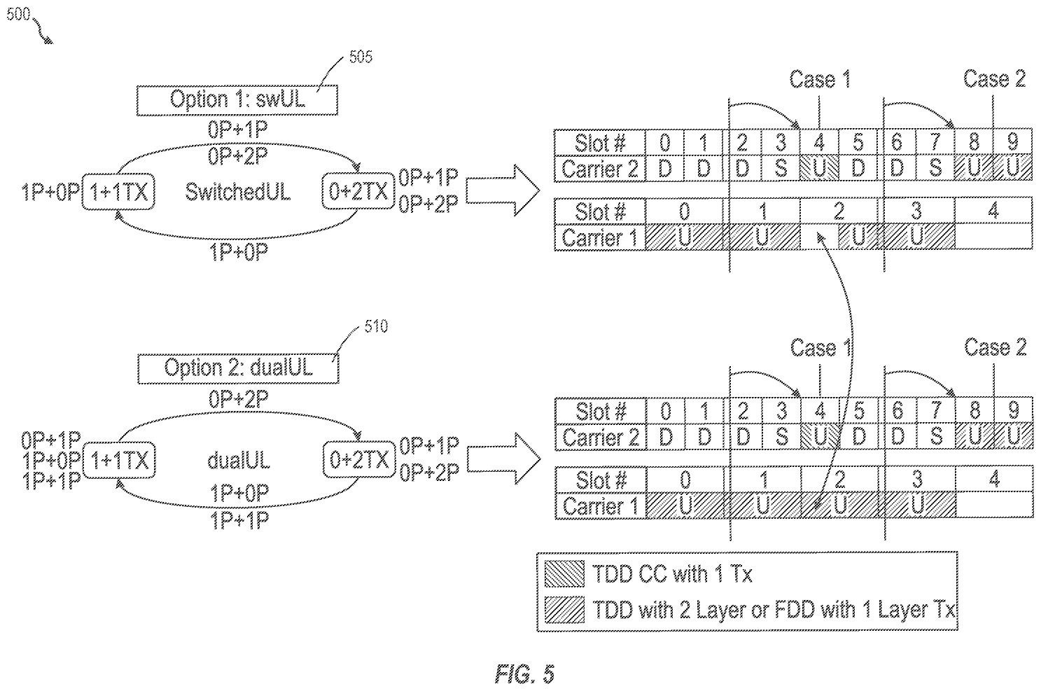

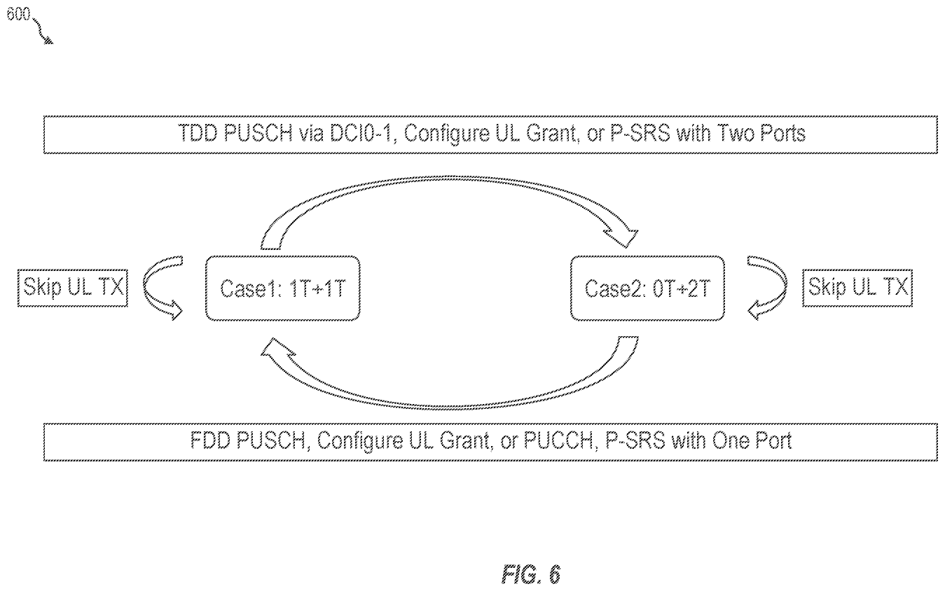

In NR Release 16-17, there are two options supported for the uplink Tx switching, namely, ‘switchedUL (or swUL)’ (e.g., Option one 505 depicted in a diagram 500 of FIG. 5) and ‘dualUL’ (e.g., Option two 510 depicted in the diagram 500 of FIG. 5). In the option one 505 of ‘switchedUL’, simultaneous transmissions on two carriers/frequency bands/CCs are not supported, which results in the uplink Tx switching equivalent to frequency band switching. And for option two 510 of ‘dualUL’, simultaneous transmissions on two carriers are supported (i.e., 1Tx+1Tx).

In some aspects, the UE may be allowed switching between different cases (e.g., as shown below in Table 1, and depicted in diagrams 500, 600, 700 of FIG. 5, FIG. 6, FIG. 7) for two uplink carriers for inter-band uplink CA. In these cases, the UE supports a maximum of two concurrent transmissions. As depicted in Table 1, for case 1, the UE has two Tx chains and is configured with one Tx chain per carrier. For case 2, the UE is configured with two Tx chains for a second carrier and no Tx chain for a first carrier. For case 3, the UE is configured with two Tx chains for the first carrier and no Tx chain for the second carrier.

TABLE 1

| | |
|---|---|
| Case 1 | 1 Tx on carrier 1 and 1 Tx on carrier 2 |
| Case 2 | 0 Tx on carrier 1 and 2 Tx on carrier 2 |
| Case 3 | 2 Tx on carrier 1 and 0 Tx on carrier 2 |

In some aspects, for the inter-band uplink CA, if the UE reports via capability signaling to support the uplink Tx switching, the UE may further report via the capability signaling which option (between switchedUL and dualUL) is supported.

For switchedUL (e.g., as shown below in Table 2): If the uplink Tx switching is configured, the UE is not expected to be scheduled or configured with the uplink transmission on the second carrier for case 1.

TABLE 2
Option 1: switchedUL

| | Number of Tx chains | Number of antenna ports for uplink |
|---|---|---|
| | (carrier 1 + carrier 2) | transmission (carrier 1 + carrier 2) |
| Case 1 | 1Tx + 1Tx | 1P + 0P |
| Case 2 | 0Tx + 2Tx | 0P + 2P, 0P + 1P |

For dualUL (e.g., as shown below in Table 3): If the uplink Tx switching is configured, the UE can be scheduled or configured with the uplink transmission on both the first carrier 1 and the second carrier for case 1. The UE can also be scheduled or configured with the uplink transmission on either the first carrier or the second carrier. The UE can also be scheduled or configured with the uplink transmission on both the first carrier 1 and the second carrier simultaneously.

TABLE 3
Option 2: dualUL

| | Number of Tx chains | Number of antenna ports for uplink |
|---|---|---|
| | (carrier 1 + carrier 2) | transmission (carrier 1 + carrier 2) |
| Case 1 | 1Tx + 1Tx | 1P + 0P, 1P + 1P, 0P + 1P |
| Case 2 | 0Tx + 2Tx | 0P + 2P, 0P + 1P |

For uplink multi-carrier operations, the UE is usually configured to use one Tx chain for the first carrier and another Tx chain for the second carrier. However, in some cases, the UE may perform the uplink Tx switching to use both its Tx chains to send data on one carrier (i.e., for a two-layer transmission by the UE). To notify the gNB that the UE may send the two-layer transmission on a given carrier, the UE may primarily use sounding reference signals (SRSs) (e.g., a two-port SRS transmission by the UE to the gNB). To send an SRS via the two antenna ports (i.e., the two-port SRS transmission), the UE may have to implement the uplink Tx switching to switch from one Tx chain per carrier configuration (which may be applicable for most transmission cases) to two Tx chains one carrier configuration. This is because the two Tx chains may be needed to send the two-port SRS transmission to the gNB.

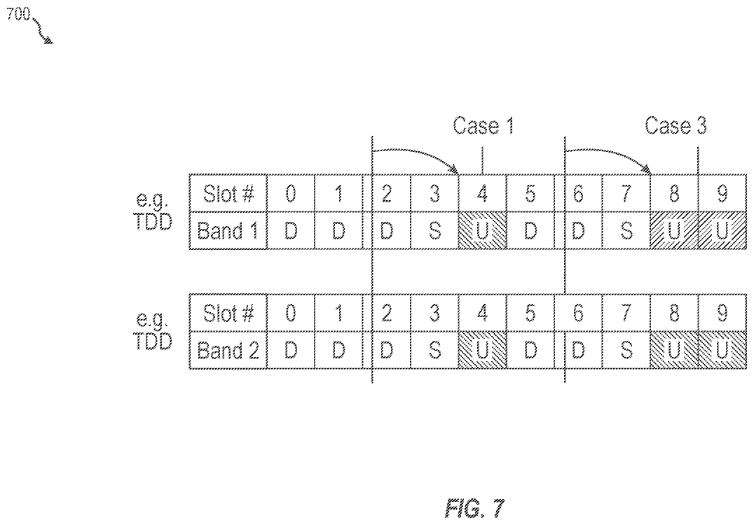

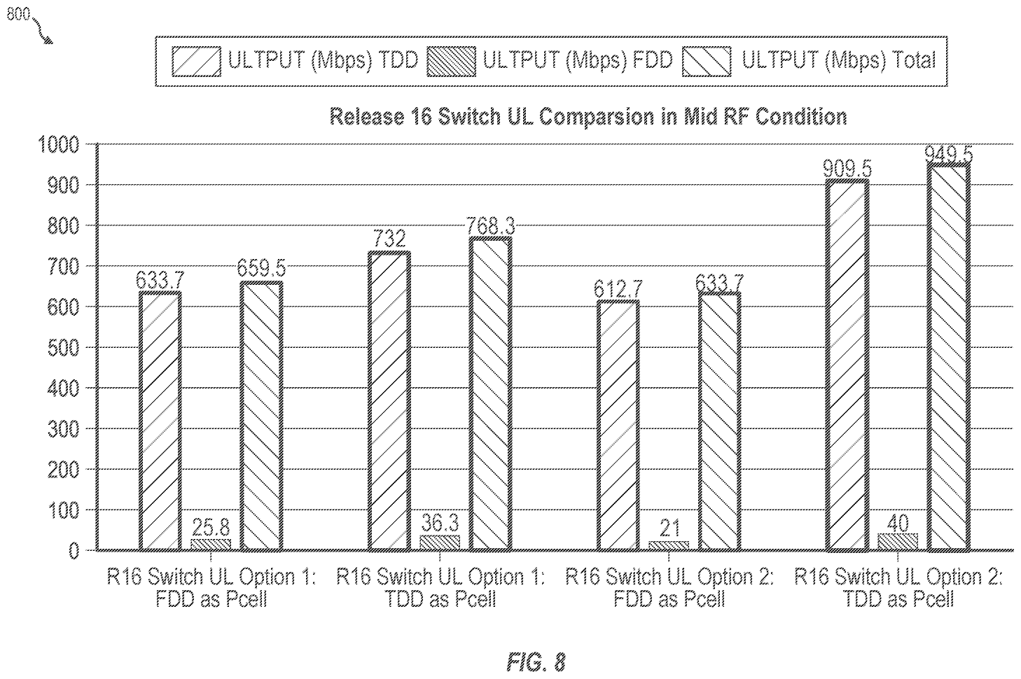

Certain issues may arise when the UE frequently implements the uplink Tx switching (e.g., each time the two-port SRS transmission is initiated by the UE). For example, a time it takes for the UE to perform the uplink Tx switching from one carrier to another carrier (e.g., referred to herein as an uplink Tx switching time) may impact when the UE can communicate on the uplink, such as a physical uplink shared channel (PUSCH). In particular, the UE may not be able to communicate on the uplink while performing the uplink Tx switching for the uplink Tx switching time, and in some cases may not be able to even prepare data for transmission on the uplink while performing the uplink Tx switching for the uplink Tx switching time. Hence, the uplink Tx switching time may affect the uplink data preparation time of the UE as well as cause a total uplink throughput loss (e.g., as the UE is not able to communicate on the uplink while performing the uplink Tx switching). Examples of total throughput for uplink Tx switching option 1 and uplink Tx switching option 2 for TDD and FDD is depicted in a diagram 800 of FIG. 8.

In some cases, it is observed that when TDD uplink signal to interference noise ratio (SINR) is not optimal for a two-layer multiple input multiple output (MIMO) transmission, the two-port SRS transmission by the UE may trigger an unnecessary uplink Tx switching, which results in the total uplink throughput loss. Also, when the TDD uplink SINR indicates a mid-radio frequency (RF) condition between a one-layer transmission and the two-layer transmission transition, an radio resource control (RRC) reconfiguration between one antenna port and two antenna ports SRS transmission may introduce a transmission delay as well as lead to RRC signaling overhead.

### Aspects Related to P-SRS Port Number Adaption for UL Switch Enhancement

Aspects of the present disclosure provide apparatuses, methods, processing systems, and computer-readable mediums for managing sounding reference signal (SRS) port patterns for single-port and multi-port SRS transmissions.

Techniques proposed herein may reduce unnecessary uplink transmit (Tx) switching, which may be triggered by initiation of a two-port SRS transmission. For example, the techniques proposed herein may support SRS port configuration adaptation instead of a fixed SRS port configuration (e.g., which may facilitate the two-port SRS transmission even when it's not needed). For example, a gNodeB (gNB) may define and configure multiple SRS port patterns for a user equipment (UE), where each SRS port pattern is unique and defines an arrangement of SRS ports for single-port SRS transmissions as well as multi-port SRS transmissions. The use of one of the SRS port patterns may prevent the UE from unnecessarily transmitting the two-port SRS transmission (e.g., where the UE can simply use a one-port SRS transmission) and thereby prevents the unnecessary triggering of the uplink Tx switching.

Particular aspects of the subject matter described in this disclosure can be implemented to realize one or more of the following potential advantages. In some examples, the described techniques can lead to a higher uplink throughput due to reduced unnecessary uplink Tx switching.

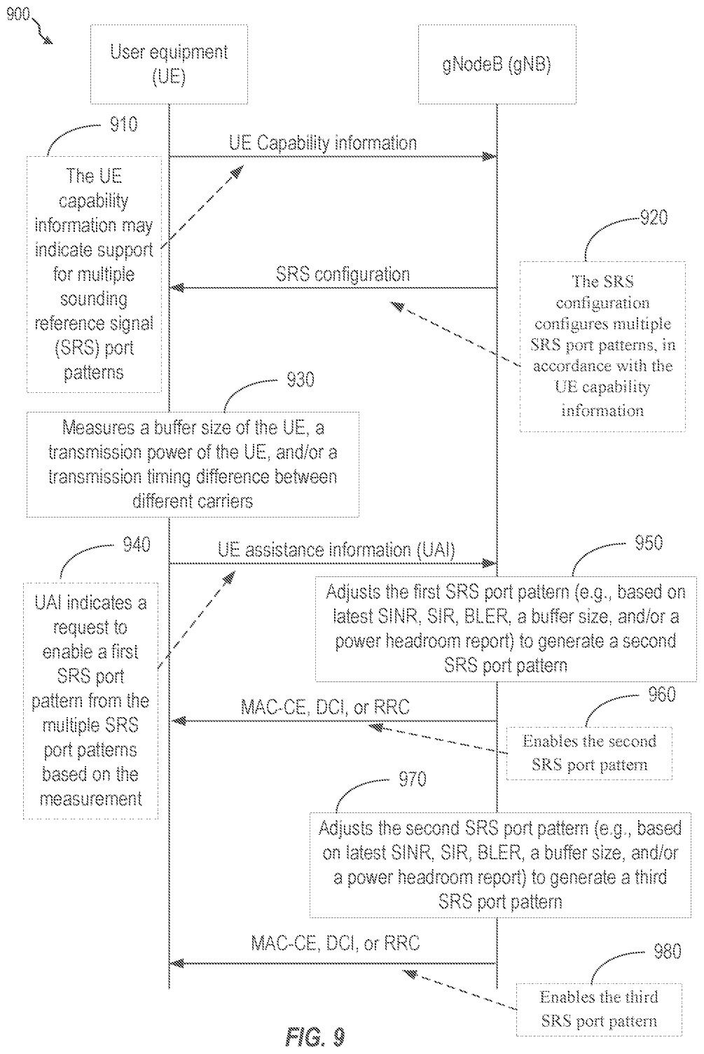

The techniques proposed herein for configuring and enabling the SRS port patterns for the single-port and multi-port SRS transmissions may be understood with reference to FIG. 9-FIG. 13.

FIG. 9 depicts a call flow diagram 900 illustrating example communication among wireless nodes such as a UE and a network entity (e.g., a gNB) for configuring and enabling SRS port patterns for single-port and multi-port SRS transmissions. The UE shown in FIG. 9 may be an example of the UE 104 depicted and described with respect to FIG. 1 and FIG. 3. The gNB depicted in FIG. 9 may be an example of the BS 102 depicted and described with respect to FIG. 1 and FIG. 3, or the disaggregated BS depicted and described with respect to FIG. 2.

As indicated at 910, the UE transmits UE capability information to the gNB. The UE capability information may indicate support for multiple SRS port patterns. Each SRS port pattern defines an arrangement of SRS ports for one or more single-port SRS transmissions (e.g., such as one or more 1-port transmissions (or one or more single-layer SRS transmissions)) and one or more multi-port SRS transmissions (e.g., such as one or more 2-port transmissions (or one or more two-layer SRS transmissions)).

In certain aspects, the UE, per the SRS port pattern, may transmit a 2-port transmission on one uplink carrier on one band and a preceding or subsequent uplink transmission may be a 1-port transmission on another uplink carrier on another band.

In certain aspects, the multiple SRS port patterns may include a first SRS port pattern, a second SRS port pattern, and a third SRS port pattern. The first SRS port pattern is different from the second SRS port pattern, and the second SRS port pattern is different from the third SRS port pattern.

The first SRS port pattern defines a first sequence or order of a first set of SRS ports configured for the one or more single-port SRS transmissions and a second set of SRS ports configured for the one or more multi-port SRS transmissions. For example, the first sequence or order indicates “2, 1, 2, 1, 2, 1 . . . ” arrangement of the SRS ports (or antenna ports), where 2 represents SRS ports (e.g., from the second set of SRS ports) for a two-port SRS transmission and 1 represents an SRS port (e.g., from the first set of SRS ports) for a single-port SRS transmission.

The second SRS port pattern defines a second sequence or order of the first set of SRS ports configured for the one or more single-port SRS transmissions and the second set of SRS ports configured for the one or more multi-port SRS transmissions. For example, the second sequence or order indicates “2, 2, 1, 2, 2, 1 . . . ” arrangement of the SRS ports, where 2 represents the SRS ports for the two-port SRS transmission and 1 represents the SRS port for the single-port SRS transmission.

The third SRS port pattern defines a third sequence or order of the first set of SRS ports configured for the one or more single-port SRS transmissions and the second set of SRS ports configured for the one or more multi-port SRS transmissions. For example, the third sequence or order indicates “2, 1, 1, 2, 1, 1 . . . ” arrangement of the SRS ports, where 2 represents the SRS ports for the two-port SRS transmission and 1 represents the SRS port for the single-port SRS transmission.

As indicated at 920, the gNB transmits an SRS configuration to the UE, in response to the received UE capability information. In one example, the SRS configuration may configure the UE with the multiple SRS port patterns. In another example, the SRS configuration may configure and enable (for use) the multiple SRS port patterns at the UE. In another example, the SRS configuration may configure the multiple SRS port patterns at the UE and enable a subset of the multiple SRS port patterns for use.

As indicated at 930, the UE measures a buffer size of the UE, a transmission power of the UE, and/or a transmission timing difference between different carriers.

In certain aspects, the UE may determine a preferred SRS port pattern (e.g., the first SRS port pattern from the multiple SRS port patterns) for use, based on some or all measurements performed by the UE. In one example, the UE may determine the preferred SRS port pattern based on the buffer size of the UE. In another example, the UE may determine the preferred SRS port pattern based on the transmission power of the UE. In another example, the UE may determine the preferred SRS port pattern based on the transmission timing difference between the different carriers. In another example, the UE may determine the preferred SRS port pattern based on the buffer size of the UE, the transmission power of the UE, and the transmission timing difference between the different carriers.

In certain aspects, the preferred SRS port pattern may be different from all of the multiple SRS port patterns configured by the gNB. That is, the UE may determine the preferred SRS port pattern on its own.

As indicated at 940, the UE transmits UE assistance information (UAI) to the gNB. The UAI may indicate a request to enable the preferred SRS port pattern, such as, the first SRS port pattern for the one or more single-port SRS transmissions and the one or more multi-port SRS transmissions by the UE.

In certain aspects, the UE may receive, in response to the request, an indication from the gNB enabling the first SRS port pattern for use at the UE. Once the first SRS port pattern is enabled, the UE may be able to transmit the one or more single-port SRS transmissions and the one or more multi-port SRS transmissions from different SRS ports arranged per the first SRS port pattern.

In certain aspects, the UAI may include the buffer size of the UE, the transmission power of the UE, and/or the transmission timing difference between different carriers. In certain aspects, the UE may periodically measure and send latest information associated with the buffer size of the UE, the transmission power of the UE, and/or the transmission timing difference between different carriers to the gNB via the UAI.

In certain aspects, as indicated at 950, the gNB, in response to the request, may adjust the first SRS port pattern (e.g., rather than enabling the first SRS port pattern).

In certain aspects, the gNB may determine current values of an uplink signal to interference noise ratio (SINR), a signal-to-interference ratio (SIR), a block error rate (BLER), a buffer size of the UE, and/or a power headroom report of the UE.

In certain aspects, the gNB may determine that the first SRS port pattern is not adequate, based on the current values of the uplink SINR, the SIR, the BLER, the buffer size of the UE, the power headroom report of the UE, and/or the UAI. In such cases, the gNB may adjust the first SRS port pattern, based on the current values of the uplink SINR, the SIR, the BLER, the buffer size of the UE, the power headroom report of the UE, and/or the UAI (i.e., adjust the first sequence or order of the first set of SRS ports and the second set of SRS ports per the first SRS port pattern). For example, the adjusted first SRS port pattern may be same as the second SRS port pattern.

In certain aspects, the gNB may determine a new SRS port pattern (as opposed to adjusting the first SRS port pattern), based on the current values of the uplink SINR, the SIR, the BLER, the buffer size of the UE, the power headroom report of the UE, and/or the UAI. In one example, the new SRS port pattern may be different from all of the multiple SRS port patterns configured by the gNB. In another example, the new SRS port pattern may be one of the multiple SRS port patterns configured by the gNB.

As indicated at 960, the gNB may transmit an indication enabling the second SRS port pattern to the UE, in response to the request from the UE. In one example, the gNB may transmit indication enabling the second SRS port pattern via a medium access control (MAC) control element (CE). In another example, the gNB may transmit indication enabling the second SRS port pattern via downlink control information (DCI). In another example, the gNB may transmit indication enabling the second SRS port pattern via radio resource control (RRC) signaling.

Once the second SRS port pattern is enabled, the UE may be able to transmit the one or more single-port SRS transmissions and the one or more multi-port SRS transmissions from different SRS ports arranged per the second SRS port pattern.

As indicated at 970, the gNB adjusts the second SRS port pattern based on newest (up-to-date) values the SINR, the SIR, the BLER, the buffer size, and/or the power headroom report (as well as the latest UAI with the latest information associated with UE-based measurements).

For example, the gNB may statically or dynamically determine and evaluate the newest values the SINR, the SIR, the BLER, the buffer size, and/or the power headroom report. Based on the evaluation and the latest UAI, the gNB may determine (on its own) to enable another SRS port pattern (e.g., and disable the second SRS port pattern). In such cases, the gNB may adjust the second SRS port pattern, based on the latest UAI and the newest values of the uplink SINR, the SIR, the BLER, the buffer size of the UE, and/or the power headroom report of the UE (i.e., adjust the second sequence or order of the first set of SRS ports and the second set of SRS ports per the second SRS port pattern). For example, the adjusted second SRS port pattern may be same as the third SRS port pattern.

In certain aspects, the gNB may determine a new SRS port pattern (as opposed to adjusting the second SRS port pattern), based on the latest UAI and the newest values of the uplink SINR, the SIR, the BLER, the buffer size of the UE, and/or the power headroom report of the UE. In one example, the new SRS port pattern may be different from all of the multiple SRS port patterns configured by the gNB. In another example, the new SRS port pattern may be one of the multiple SRS port patterns configured by the gNB.

As indicated at 980, the gNB may transmit an indication enabling the third SRS port pattern to the UE via the MAC-CE, the DCI, or the RRC (i.e, dynamically change an SRS port pattern from the second SRS port pattern to the third SRS port pattern). Once the third SRS port pattern is enabled, the UE may be able to transmit the one or more single-port SRS transmissions and the one or more multi-port SRS transmissions from different SRS ports arranged per the third SRS port pattern.

### Example Method for Wireless Communications at a User Equipment (UE)

FIG. 10 shows an example of a method 1000 for wireless communications at a wireless node. The wireless node may be a user equipment (UE), such as the UE 104 of FIG. 1 and FIG. 3.

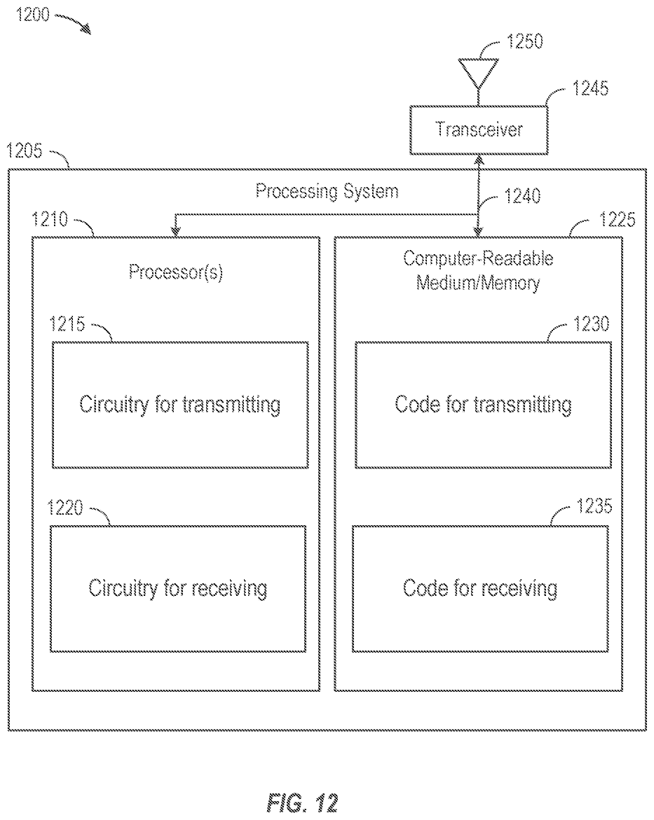

Method 1000 begins at step 1010 with transmitting UE capability information indicating support for multiple sounding reference signal (SRS) port patterns where each SRS port pattern defines a series of SRS transmissions and indicates whether each SRS transmission is a single-port SRS transmission or a multi-port SRS transmission. In some cases, the operations of this step refer to, or may be performed by, circuitry for transmitting and/or code for transmitting as described with reference to FIG. 12.

Method 1000 then proceeds to step 1020 with receiving a configuration of the multiple SRS port patterns, in accordance with the UE capability information. In some cases, the operations of this step refer to, or may be performed by, circuitry for receiving and/or code for receiving as described with reference to FIG. 14.

In certain aspects, the method 1000 further includes measuring at least one of: a buffer size of the UE, a transmission power of the UE, or a transmission timing difference between different carriers; and determining a first SRS port pattern from the multiple SRS port patterns based on the measurement, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

In certain aspects, the method 1000 further includes transmitting UE assistance information (UAI) indicating a request to enable the first SRS port pattern for the single-port SRS transmissions and the multi-port SRS transmissions.

In certain aspects, the method 1000 further includes receiving, in response to the request, an indication enabling the first SRS port pattern for the single-port SRS transmissions and the multi-port SRS transmissions.

In certain aspects, the method 1000 further includes transmitting the single-port SRS transmissions and the multi-port SRS transmissions per the first SRS port pattern.

In certain aspects, the method 1000 further includes receiving, in response to the request, an indication enabling an adjusted first SRS port pattern for the single-port SRS transmissions and the multi-port SRS transmissions, wherein the adjusted first SRS port pattern indicates a modified sequence of the first set of SRS ports and the second set of SRS ports.

In certain aspects, the adjusted first SRS port pattern is based on at least one of: an uplink signal to interference noise ratio (SINR), a signal-to-interference ratio (SIR), a block error rate (BLER), a buffer size, or a power headroom report.

In certain aspects, the method 1000 further includes receiving an indication enabling a first SRS port pattern of the multiple SRS port patterns, via at least one of a medium access control (MAC) control element (CE), a downlink control information (DCI) or radio resource control (RRC) signaling, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

In certain aspects, the first SRS port pattern is based on at least one of: an uplink signal to interference noise ratio (SINR), a signal-to-interference ratio (SIR), a block error rate (BLER), a buffer size, a power headroom report, or UE assistance information (UAI) of the UE.

In one aspect, the method 1000, or any aspect related to it, may be performed by an apparatus, such as a communications device 1200 of FIG. 12, which includes various components operable, configured, or adapted to perform the method 1000. The communications device 1200 is described below in further detail.

Note that FIG. 10 is just one example of a method, and other methods including fewer, additional, or alternative steps are possible consistent with this disclosure.

### Example Method for Wireless Communications at a Network Entity

FIG. 11 shows an example of a method 1100 for wireless communications at a wireless node. The wireless node may be a network entity, such as the BS 102 of FIG. 1 and FIG. 3.

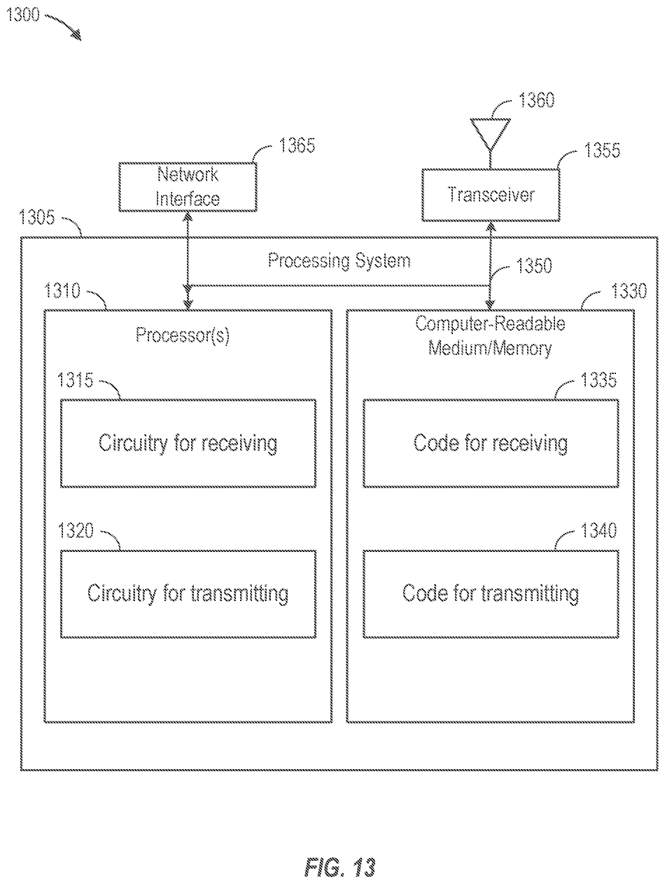

Method 1100 begins at step 1110 with receiving user equipment (UE) capability information indicating support for multiple sounding reference signal (SRS) port patterns where each SRS port pattern defines a series of SRS transmissions and indicates whether each SRS transmission is a single-port SRS transmission or a multi-port SRS transmission. In some cases, the operations of this step refer to, or may be performed by, circuitry for receiving and/or code for receiving as described with reference to FIG. 13.

Method 1100 then proceeds to step 1120 with transmitting a configuration of the multiple SRS port patterns, in accordance with the UE capability information. In some cases, the operations of this step refer to, or may be performed by, circuitry for transmitting and/or code for transmitting as described with reference to FIG. 13.

In certain aspects, the method 1100 further includes receiving UE assistance information (UAI) indicating a request to enable a first SRS port pattern from the multiple SRS port patterns, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

In certain aspects, the method 1100 further includes transmitting, in response to the request, an indication enabling the first SRS port pattern for the single-port SRS transmissions and the multi-port SRS transmissions.

In certain aspects, the method 1100 further includes receiving the single-port SRS transmissions and the multi-port SRS transmissions per the first SRS port pattern.

In certain aspects, the method 1100 further includes transmitting, in response to the request, an indication enabling an adjusted first SRS port pattern for the single-port SRS transmissions and the multi-port SRS transmissions, wherein the adjusted first SRS port pattern indicates a modified sequence of the first set of SRS ports and the second set of SRS ports.

In certain aspects, the method 1100 further includes transmitting an indication enabling a first SRS port pattern of the multiple SRS port patterns, via at least one of a medium access control (MAC) control element (CE), a downlink control information (DCI) or radio resource control (RRC) signaling, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

In certain aspects, the first SRS port pattern is based on at least one of: an uplink signal to interference noise ratio (SINR), a signal-to-interference ratio (SIR), a block error rate (BLER), a buffer size, a power headroom report, or UE assistance information (UAI) of the UE.

In one aspect, the method 1100, or any aspect related to it, may be performed by an apparatus, such as a communications device 1300 of FIG. 13, which includes various components operable, configured, or adapted to perform the method 1100. The communications device 1300 is described below in further detail.

Note that FIG. 11 is just one example of a method, and other methods including fewer, additional, or alternative steps are possible consistent with this disclosure.

### Example Communications Devices

FIG. 12 depicts aspects of an example communications device 1200. In some aspects, communications device 1200 is a user equipment (UE), such as UE 104 described above with respect to FIG. 1 and FIG. 3.

The communications device 1200 includes a processing system 1205 coupled to a transceiver 1245 (e.g., a transmitter and/or a receiver). The transceiver 1245 is configured to transmit and receive signals for the communications device 1200 via an antenna 1250, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. The one or more processors 1210 are coupled to a computer-readable medium/memory 1225 via a bus 1240. In certain aspects, the computer-readable medium/memory 1225 is configured to store instructions (e.g., computer-executable code) that when executed by the one or more processors 1210, cause the one or more processors 1210 to perform the method 1000 described with respect to FIG. 10, and/or any aspect related to it. Note that reference to a processor performing a function of communications device 1200 may include the one or more processors 1210 performing that function of communications device 1200.

In the depicted example, computer-readable medium/memory 1225 stores code (e.g., executable instructions), such as code for transmitting 1230 and code for receiving 1235. Processing of the code for transmitting 1230 and the code for receiving 1235 may cause the communications device 1200 to perform the method 1000 described with respect to FIG. 10, and/or any aspect related to it.

The one or more processors 1210 include circuitry configured to implement (e.g., execute) the code stored in the computer-readable medium/memory 1225, including circuitry such as circuitry for transmitting 1215 and circuitry for receiving 1220. Processing with the circuitry for transmitting 1215 and the circuitry for receiving 1220 may cause the communications device 1200 to perform the method 1000 described with respect to FIG. 10, and/or any aspect related to it.

Various components of the communications device 1200 may provide means for performing the method 1000 described with respect to FIG. 10, and/or any aspect related to it. For example, means for transmitting, sending or outputting for transmission may include transceivers 354 and/or antenna(s) 352 of the UE 104 illustrated in FIG. 3 and/or the code for transmitting 1230, the circuitry for transmitting 1215, the transceiver 1245 and the antenna 1250 of the communications device 1200 in FIG. 12. Means for receiving or obtaining may include transceivers 354 and/or antenna(s) 352 of the UE 104 illustrated in FIG. 3 and/or the code for receiving 1235, the circuitry for receiving 1220, the transceiver 1245 and the antenna 1250 of the communications device 1200 in FIG. 12.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 12 is an example, and many other examples and configurations of communication device 1200 are possible.

FIG. 13 depicts aspects of an example communications device 1300. In some aspects, communications device 1300 is a network entity, such as BS 102 of FIG. 1 and FIG. 3, or a disaggregated base station as discussed with respect to FIG. 2.

The communications device 1300 includes a processing system 1305 coupled to a transceiver 1355 (e.g., a transmitter and/or a receiver) and/or a network interface 1365. The transceiver 1355 is configured to transmit and receive signals for the communications device 1300 via an antenna 1360, such as the various signals as described herein. The network interface 1365 is configured to obtain and send signals for the communications device 1300 via communication link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1330 via a bus 1350. In certain aspects, the computer-readable medium/memory 1330 is configured to store instructions (e.g., computer-executable code) that when executed by the one or more processors 1310, cause the one or more processors 1310 to perform the method 1100 described with respect to FIG. 11, or any aspect related to it. Note that reference to a processor of communications device 1300 performing a function may include the one or more processors 1310 of communications device 1300 performing that function.

In the depicted example, the computer-readable medium/memory 1330 stores code (e.g., executable instructions), such as code for receiving 1335 and code for transmitting 1340. Processing of the code for receiving 1335 and the code for transmitting 1340 may cause the communications device 1300 to perform the method 1100 described with respect to FIG. 11, or any aspect related to it.

The one or more processors 1310 include circuitry configured to implement (e.g., execute) the code stored in the computer-readable medium/memory 1330, including circuitry such as circuitry for receiving 135 and circuitry for transmitting 1320. Processing with the circuitry for receiving 1315 and the circuitry for transmitting 1320 may cause the communications device 1300 to perform the method 1100 described with respect to FIG. 11, or any aspect related to it.

Various components of the communications device 1300 may provide means for performing the method 1100 described with respect to FIG. 11, or any aspect related to it. Means for transmitting, sending or outputting for transmission may include transceivers 332 and/or antenna(s) 334 of the BS 102 illustrated in FIG. 3 and/or the circuitry for transmitting 1320, the code for transmitting 1340, the transceiver 1355 and the antenna 1360 of the communications device 1300 in FIG. 13. Means for receiving or obtaining may include transceivers 332 and/or antenna(s) 334 of the BS 102 illustrated in FIG. 3 and/or the circuitry for receiving 1315, the code for receiving 1335, the transceiver 1355 and the antenna 1360 of the communications device 1300 in FIG. 13.

In some cases, rather than actually transmitting, for example, signals and/or data, a device may have an interface to output signals and/or data for transmission (a means for outputting). For example, a processor may output signals and/or data, via a bus interface, to an RF front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 13 is an example, and many other examples and configurations of communication device 1300 are possible.

### Example Clauses

Implementation examples are described in the following numbered clauses:

Clause 1: A method for wireless communications at a user equipment (UE), comprising: transmitting UE capability information indicating support for multiple sounding reference signal (SRS) port patterns, wherein each SRS port pattern defines a series of SRS transmissions and indicates whether each SRS transmission is a single-port SRS transmission or a multi-port SRS transmission; and receiving a configuration of the multiple SRS port patterns, in accordance with the UE capability information.

Clause 2: The method of clause 1, further comprising: measuring at least one of: a buffer size of the UE, a transmission power of the UE, or a transmission timing difference between different carriers; and determining a first SRS port pattern from the multiple SRS port patterns based on the measurement, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

Clause 3: The method of clause 2, further comprising transmitting UE assistance information (UAI) indicating a request to enable the first SRS port pattern for the single-port SRS transmissions and the multi-port SRS transmissions.

Clause 4: The method of clause 3, further comprising receiving, in response to the request, an indication enabling the first SRS port pattern for the single-port SRS transmissions and the multi-port SRS transmissions.

Clause 5: The method of clause 4, further comprising transmitting the single-port SRS transmissions and the multi-port SRS transmissions per the first SRS port pattern.

Clause 6: The method of clause 3, further comprising receiving, in response to the request, an indication for an adjusted first SRS port pattern for the single-port SRS transmissions and the multi-port SRS transmissions, wherein the adjusted first SRS port pattern indicates a modified sequence of the first set of SRS ports and the second set of SRS ports.

Clause 7: The method of clause 6, wherein the first SRS port pattern is adjusted based on at least one of: an uplink signal to interference noise ratio (SINR), a signal-to-interference ratio (SIR), a block error rate (BLER), or a power headroom report.

Clause 8: The method of any one of clauses 1-7, further comprising receiving an indication enabling a first SRS port pattern of the multiple SRS port patterns, via at least one of a medium access control (MAC) control element (CE), a downlink control information (DCI) or radio resource control (RRC) signaling, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

Clause 9: The method of clause 8, wherein the first SRS port pattern is determined for the UE based on at least one of: an uplink signal to interference noise ratio (SINR), a signal-to-interference ratio (SIR), a block error rate (BLER), a power headroom report, or UE assistance information (UAI) of the UE.

Clause 10: A method for wireless communications at a network entity, comprising: receiving user equipment (UE) capability information indicating support for multiple sounding reference signal (SRS) port patterns, wherein each SRS port pattern defines a series of SRS transmissions and indicates whether each SRS transmission is a single-port SRS transmission or a multi-port SRS transmission; and transmitting a configuration of the multiple SRS port patterns, in accordance with the UE capability information.

Clause 11: The method of clause 10, further comprising receiving UE assistance information (UAI) indicating a request to enable a first SRS port pattern from the multiple SRS port patterns, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

Clause 12: The method of clause 11, further comprising transmitting, in response to the request, an indication enabling the first SRS port pattern for the single-port SRS transmissions and the multi-port SRS transmissions.

Clause 13: The method of clause 12, further comprising receiving the single-port SRS transmissions and the multi-port SRS transmissions per the first SRS port pattern.

Clause 14: The method of clause 11, further comprising transmitting, in response to the request, an indication enabling an adjusted first SRS port pattern for the single-port SRS transmissions and the multi-port SRS transmissions, wherein the adjusted first SRS port pattern indicates a modified sequence of the first set of SRS ports and the second set of SRS ports.

Clause 15: The method of any one of clauses 10-14, further comprising transmitting an indication enabling a first SRS port pattern of the multiple SRS port patterns, via at least one of a medium access control (MAC) control element (CE), a downlink control information (DCI) or radio resource control (RRC) signaling, wherein the first SRS port pattern a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

Clause 16: The method of clause 15, wherein the first SRS port pattern is based on at least one of: an uplink signal to interference noise ratio (SINR), a signal-to-interference ratio (SIR), a block error rate (BLER), a power headroom report, or UE assistance information (UAI) of the UE.

Clause 17: An apparatus, comprising: a memory comprising executable instructions; and one or more processors configured, individually or in any combination, to execute the executable instructions and cause the apparatus to perform a method in accordance with any one of Clauses 1-16.

Clause 18: An apparatus, comprising means for performing a method in accordance with any one of Clauses 1-16.

Clause 19: A non-transitory computer-readable medium comprising executable instructions that, when executed by one or more processors of an apparatus, cause the apparatus to perform a method in accordance with any one of Clauses 1-16.

Clause 20: A computer program product embodied on a computer-readable storage medium comprising code for performing a method in accordance with any one of Clauses 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term wireless node may refer to, for example, a network entity or a UE. In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
a memory comprising instructions; and
one or more processors configured, individually or in any combination, to execute the instructions and cause the apparatus to:
transmit UE capability information indicating support for multiple sounding reference signal (SRS) port patterns, wherein each SRS port pattern defines a series of SRS transmissions and indicates whether each SRS transmission is a single-port SRS transmission or a multi-port SRS transmission; and
receive a configuration of the multiple SRS port patterns, in accordance with the UE capability information.

2. The apparatus of claim 1, wherein the one or more processors are configured, individually or in any combination, to execute the instructions and cause the apparatus to:
measure at least one of: a buffer size of the UE, a transmission power of the UE, or a transmission timing difference between different carriers; and
determine a first SRS port pattern from the multiple SRS port patterns based on the measurement, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

3. The apparatus of claim 2, wherein the one or more processors are configured, individually or in any combination, to execute the instructions and cause the apparatus to transmit UE assistance information (UAI) indicating a request to enable the first SRS port pattern for the single-port SRS transmissions and the multi-port SRS transmissions.

4. The apparatus of claim 3, wherein the one or more processors are configured, individually or in any combination, to execute the instructions and cause the apparatus to receive, in response to the request, an indication enabling the first SRS port pattern for the single-port SRS transmissions and the multi-port SRS transmissions.

5. The apparatus of claim 4, wherein the one or more processors are configured, individually or in any combination, to execute the instructions and cause the apparatus to transmit the single-port SRS transmissions and the multi-port SRS transmissions per the first SRS port pattern.

6. The apparatus of claim 3, wherein the one or more processors are configured, individually or in any combination, to execute the instructions and cause the apparatus to receive, in response to the request, an indication for an adjusted first SRS port pattern for the single-port SRS transmissions and the multi-port SRS transmissions, wherein the adjusted first SRS port pattern indicates a modified sequence of the first set of SRS ports and the second set of SRS ports.

7. The apparatus of claim 6, wherein the first SRS port pattern is adjusted based on at least one of: an uplink signal to interference noise ratio (SINR), a signal-to-interference ratio (SIR), a block error rate (BLER), or a power headroom report.

8. The apparatus of claim 1, wherein the one or more processors are configured, individually or in any combination, to execute the instructions and cause the apparatus to receive an indication enabling a first SRS port pattern of the multiple SRS port patterns, via at least one of a medium access control (MAC) control element (CE), a downlink control information (DCI) or radio resource control (RRC) signaling, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

9. The apparatus of claim 8, wherein the first SRS port pattern is determined for the UE based on at least one of: an uplink signal to interference noise ratio (SINR), a signal-to-interference ratio (SIR), a block error rate (BLER), a power headroom report, or UE assistance information (UAI) of the UE.

10. An apparatus for wireless communications at a network entity, comprising:
a memory comprising instructions; and
one or more processors configured, individually or in any combination, to execute the instructions and cause the apparatus to:
receive user equipment (UE) capability information indicating support for multiple sounding reference signal (SRS) port patterns, wherein each SRS port pattern defines a series of SRS transmissions and indicates whether each SRS transmission is a single-port SRS transmission or a multi-port SRS transmission; and
transmit a configuration of the multiple SRS port patterns, in accordance with the UE capability information.

11. The apparatus of claim 10, wherein the one or more processors are configured, individually or in any combination, to execute the instructions and cause the apparatus to receive UE assistance information (UAI) indicating a request to enable a first SRS port pattern from the multiple SRS port patterns, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

12. The apparatus of claim 11, wherein the one or more processors are configured, individually or in any combination, to execute the instructions and cause the apparatus to transmit, in response to the request, an indication enabling the first SRS port pattern for the single-port SRS transmissions and the multi-port SRS transmissions.

13. The apparatus of claim 12, wherein the one or more processors are configured, individually or in any combination, to execute the instructions and cause the apparatus to receive the single-port SRS transmissions and the multi-port SRS transmissions per the first SRS port pattern.

14. The apparatus of claim 11, wherein the one or more processors are configured, individually or in any combination, to execute the instructions and cause the apparatus to transmit, in response to the request, an indication enabling an adjusted first SRS port pattern for the single-port SRS transmissions and the multi-port SRS transmissions, wherein the adjusted first SRS port pattern defines a modified sequence of the first set of SRS ports and the second set of SRS ports.

15. The apparatus of claim 10, wherein the one or more processors are configured, individually or in any combination, to execute the instructions and cause the apparatus to transmit an indication enabling a first SRS port pattern of the multiple SRS port patterns, via at least one of a medium access control (MAC) control element (CE), a downlink control information (DCI) or radio resource control (RRC) signaling, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

16. The apparatus of claim 15, wherein the first SRS port pattern is based on at least one of: an uplink signal to interference noise ratio (SINR), a signal-to-interference ratio (SIR), a block error rate (BLER), a power headroom report, or UE assistance information (UAI) of the UE.

17. A method for wireless communications at a user equipment (UE), comprising:
transmitting UE capability information indicating support for multiple sounding reference signal (SRS) port patterns, wherein each SRS port pattern defines a series of SRS transmissions and indicates whether each SRS transmission is a single-port SRS transmission or a multi-port SRS transmission; and
receiving a configuration of the multiple SRS port patterns, in accordance with the UE capability information.

18. The method of claim 17, further comprising:
measuring at least one of: a buffer size of the UE, a transmission power of the UE, or a transmission timing difference between different carriers; and
determining a first SRS port pattern from the multiple SRS port patterns based on the measurement, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

19. The method of claim 18, further comprising transmitting UE assistance information (UAI) indicating a request to enable the first SRS port pattern for the single-port SRS transmissions and the multi-port SRS transmissions.

20. The method of claim 19, further comprising receiving, in response to the request, an indication enabling the first SRS port pattern for the single-port SRS transmissions and the multi-port SRS transmissions.

21. The method of claim 20, further comprising transmitting the single-port SRS transmissions and the multi-port SRS transmissions per the first SRS port pattern.

22. The method of claim 19, further comprising receiving, in response to the request, an indication for an adjusted first SRS port pattern for the single-port SRS transmissions and the multi-port SRS transmissions, wherein the adjusted first SRS port pattern defines a modified sequence of the first set of SRS ports and the second set of SRS ports.

23. The method of claim 22, wherein the first SRS port pattern is adjusted based on at least one of: an uplink signal to interference noise ratio (SINR), a signal-to-interference ratio (SIR), a block error rate (BLER), or a power headroom report.

24. The method of claim 17, further comprising receiving an indication enabling a first SRS port pattern of the multiple SRS port patterns, via at least one of a medium access control (MAC) control element (CE), a downlink control information (DCI) or radio resource control (RRC) signaling, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

25. The method of claim 24, wherein the first SRS port pattern is determined for the UE based on at least one of: an uplink signal to interference noise ratio (SINR), a signal-to-interference ratio (SIR), a block error rate (BLER), a power headroom report, or UE assistance information (UAI) of the UE.

26. A method for wireless communications at a network entity, comprising:
receiving user equipment (UE) capability information indicating support for multiple sounding reference signal (SRS) port patterns, wherein each SRS port pattern defines a series of SRS transmissions and indicates whether each SRS transmission is a single-port SRS transmission or a multi-port SRS transmission; and
transmitting a configuration of the multiple SRS port patterns, in accordance with the UE capability information.

27. The method of claim 26, further comprising receiving UE assistance information (UAI) indicating a request to enable a first SRS port pattern from the multiple SRS port patterns, wherein the first SRS port pattern defines a first series of SRS transmissions and indicates a sequence of a first set of SRS ports configured for single-port SRS transmissions of the first series of SRS transmissions and a second set of SRS ports configured for multi-port SRS transmissions of the first series of SRS transmissions.

28. The method of claim 27, further comprising transmitting, in response to the request, an indication enabling the first SRS port pattern for the single-port SRS transmissions and the multi-port SRS transmissions.

29. The method of claim 28, further comprising receiving the single-port SRS transmissions and the multi-port SRS transmissions per the first SRS port pattern.

30. The method of claim 27, further comprising transmitting, in response to the request, an indication enabling an adjusted first SRS port pattern for the single-port SRS transmissions and the multi-port SRS transmissions, wherein the adjusted first SRS port pattern defines a modified sequence of the first set of SRS ports and the second set of SRS ports.
